(19) United States
(12) Patent Application Publication
(10) Pub. No.: US 2025/0051143 A1
(43) Pub. Date: Feb. 13, 2025

(54) Timber Processing System and Method

(71) Applicant: Kelly Olsen, Duluth, MN (US)

(72) Inventor: Kelly Olsen, Duluth, MN (US)

(21) Appl. No.: 18/800,103

(22) Filed: Aug. 11, 2024

Related U.S. Application Data
(60) Provisional application No. 63/532,130, filed on Aug. 11, 2023.

(51) Int. Cl. B66C 1/58

(52) U.S. Cl. CPC B66C 1/585

(57) ABSTRACT

A system and method for processing timber into firewood includes in one embodiment a pair of grapples used to place and hold logs in position for cutting, wherein a first grapple is relatively stationary and the second grapple is movable relative to the first, and a cutter is provided adjacent the second grapple on the side of the second grapple opposite the first grapple. A splitter may be provided for splitting the cut pieces into manageable sizes. Alternately, rollers or other log-moving apparatus may be used in place of the second grapple.

### RELATED APPLICATIONS

This application is related to and claims priority from pending U.S. provisional patent application Ser. No. 63/532,130, filed Aug. 11, 2023, entitled Timber Processing System and Method, which is hereby incorporated by reference herein for all purposes.

### FIELD OF THE DISCLOSURE

The invention relates generally to system and method for processing timber into firewood, and more specifically, to a skid steer, tractor, or other similar carrier machine attachment for cutting timber pieces into desired sizes.

### BACKGROUND

A number of systems exist that may be used to process timber. By way of example only, chain saws may be used to cut a log into desired lengths, and log splitters may be used to split the cut logs into desired sizes. However, such systems for processing timber are not without their drawbacks. Many systems cannot handle both short pieces of logs and long logs up to tree length. Many systems do not work well with crooked logs. Many systems do not permit the cutting of multiple logs at one time. And, many systems do not allow logs to be picked up from any angle, e.g., from an uneven pile of logs.

Thus, there remains a need for an improved system and method for processing timber.

### SUMMARY

The present disclosure provides a system and method for processing timber into firewood. A pair of grapples may be used to place and hold logs in position for cutting. A splitter may be provided for splitting the cut pieces into manageable sizes.

Other benefits and advantages of the present disclosure will be appreciated from the following detailed description.

### DESCRIPTION OF THE DRAWINGS

Exemplary embodiments of an exemplary system and method for timber processing are shown in the accompanying drawings.

FIG. 1 is a rear perspective view from a first side of an exemplary embodiment of a timber processing system including two grapples.

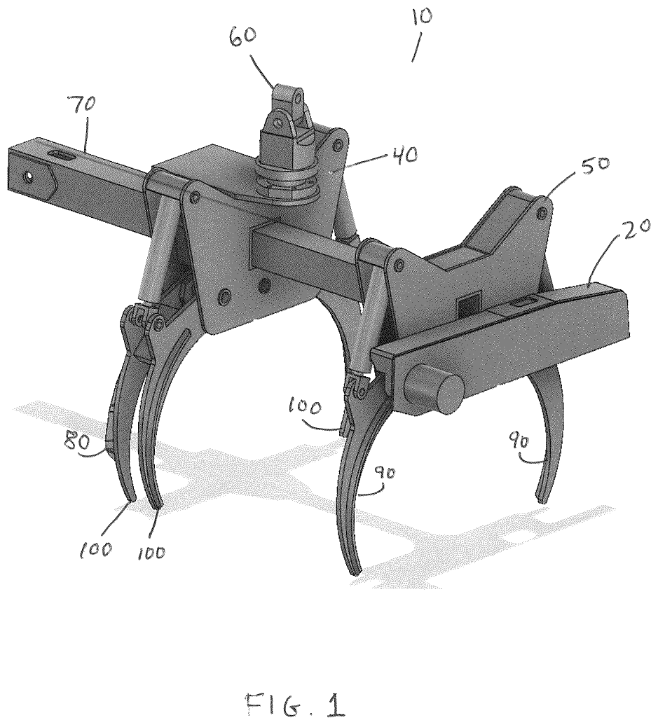

FIG. 2 is a front perspective view from a second side of the exemplary embodiment of the timber processing system shown in FIG. 1.

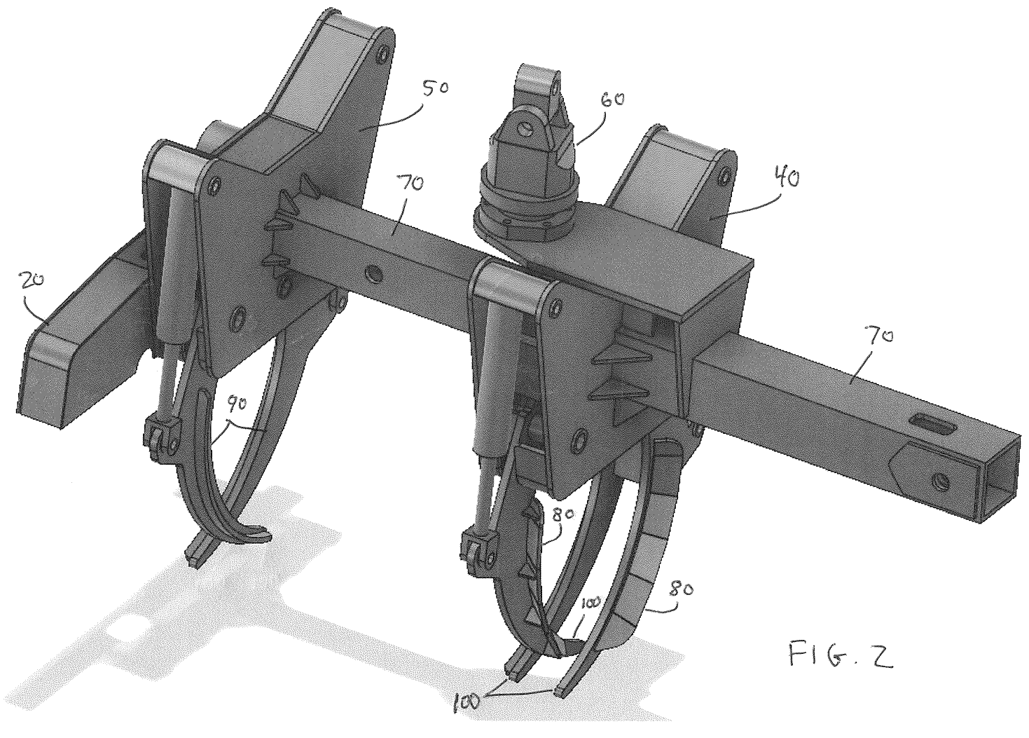

FIG. 3 is a rear perspective view of the exemplary embodiment of the timber processing system shown in FIG. 1, including the first side sliding grapple moved adjacent to the second side stationary grapple.

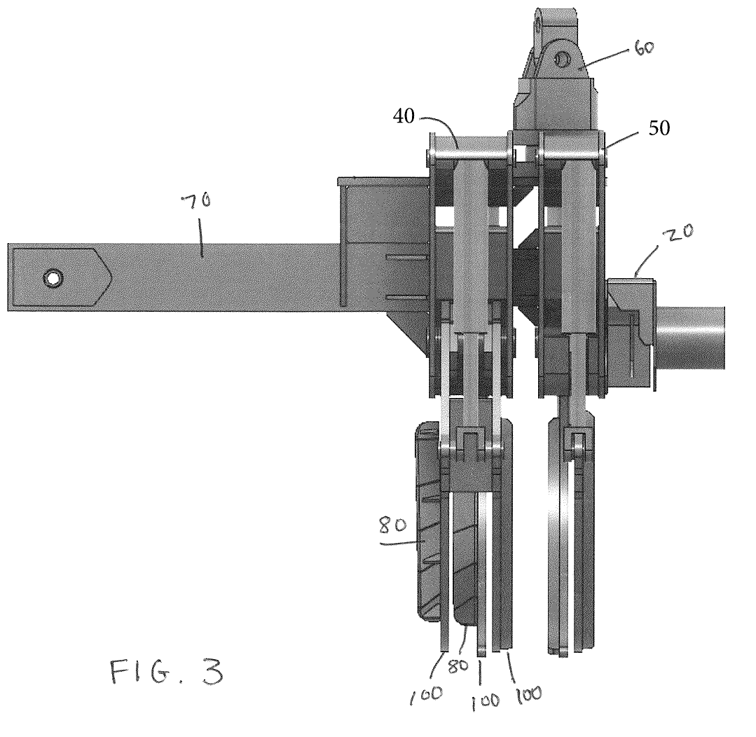

FIG. 4 is a first side rear perspective view of the exemplary embodiment of the timber processing system shown in FIG. 1, including the two grapples holding a log to be cut.

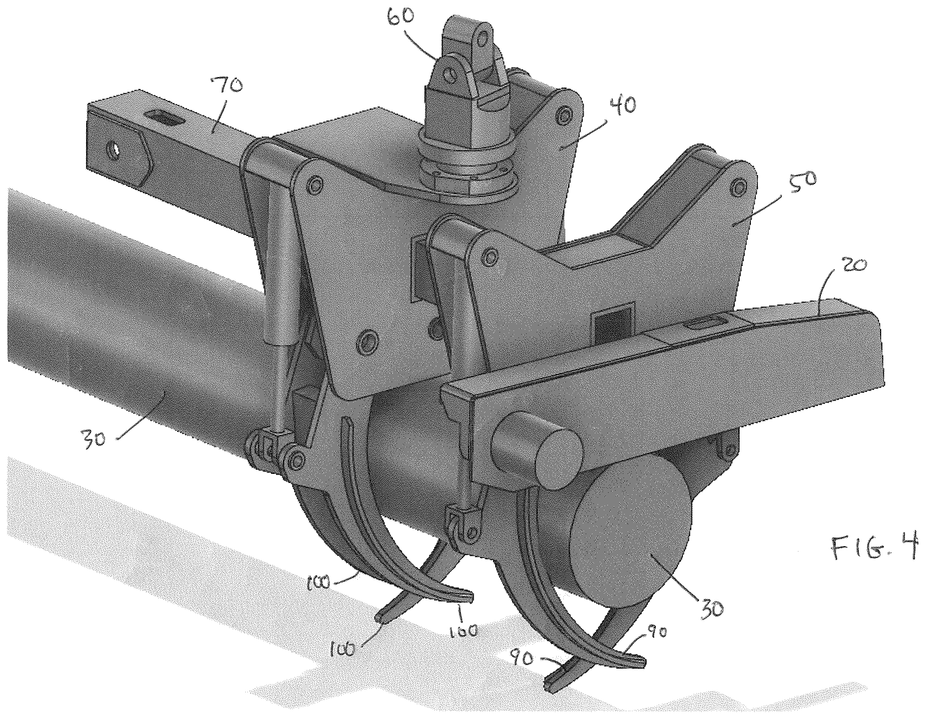

FIG. 5 is a first side rear perspective view of the exemplary embodiment of the timber processing system shown in FIG. 4, wherein the first side sliding grapple has moved adjacent to the second side stationary grapple, and wherein a saw is cutting the log.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to timber processing; etc. Such aspects related to this disclosure do not depart from the invention, and it is therefore intended that the invention not be limited by the certain aspects set forth of the events and circumstances related to this disclosure.

In one embodiment, a firewood processor is mounted on a skid steer, wheel loader, log loader, excavator, telehandler or other carrier machine using a boom, loader arm or frame between the processor and the carrier machine. The processor includes at least a grapple assembly 10 and a saw/cutting unit 20 configured to cut “blocks” of firewood from the end of a log 30. The grapple assembly 10 does not split firewood, but is used to cut the logs 30 into firewood-size chunks. If the logs 30 require splitting, then the grapple assembly 10 is used in conjunction with a log splitter. The log splitter may be mounted with the grapple assembly 10 on a skid steer, wheel loader, log loader, excavator, telehandler or other carrier machine to form a complete firewood processor. In an alternate embodiment, the grapple assembly 10 is used in conjunction with a separate log splitter, with the firewood processor cutting the logs and the logs being split using a separate log splitting machine. A conveyor may move the cut firewood blocks from the firewood processor to the log splitter, or the firewood processor may deposit the cut firewood blocks near or on the log splitter.

The grapple assembly 10 includes two grapples 40, 50. A first grapple 40 may be connected at its top to a boom, loader arm or a frame via a connector 60 that may include a 4-way link and a rotator to allow the first grapple 40 to pivot left/right/forward/back and to be spun to align with a log 30 to be picked up. A second grapple 50 is inline with and slidably attached to the first grapple 40 or connecting frame. The second grapple 50 is mounted on a slider 70 that allows the second grapple 50 to move side to side, i.e., towards, and away from, the stationary first grapple 40. The sliding second grapple 50 in one embodiment has a hydraulic chainsaw/cutting unit and a safety cover 20 mounted to it. In another embodiment, the chainsaw/cutting unit is mounted proximate the second grapple 50 on the slider 70. The slider 70 may include a hydraulically moveable frame fixedly attached to the second grapple 50 and movable relative to the first grapple 40.

The grapples 40, 50 may be similar in shape/geometry, or they may be different. For example, the stationary first grapple 40 may be shaped to primarily pick up and hold a log 30, while the sliding second grapple 50 may be designed more for pulling/sliding the log 30 through the stationary first grapple 40. The stationary first grapple 40 may be smooth and have “ramps” 80 to help promote movement of the log 30 through the grapple 40 and the second sliding grapple 50 may have ridges or serrated edges 90 to better clamp the log 30 for better grip while moving/advancing the log 30.

In use, the sliding second grapple 50 grasps a log 30 firmly, while the stationary grapple 40 includes tongs or claws 100 that are positioned about the log but slightly open. When moving the sliding second grapple 50 away from the stationary first grapple 40, the log 30 is moved along with the sliding grapple 50. The log 30 moves relative to the stationary first grapple 40. In one embodiment, the claws or tongs 100 of the stationary grapple 40 include ramps 80 that promote movement of the log 30 through the claws or tongs 100 of the stationary first grapple 40. The ramps 80 making sliding the log 30 through the tongs or claws 100 of the stationary grapple 40 easier. Also, in one embodiment, the portions of the grapples 40, 50 between the upper ends of their tongs or claws (i.e., the lower grapple frames) may include ramps or rollers to promote the movement of logs relative to the grapples 40, 50.

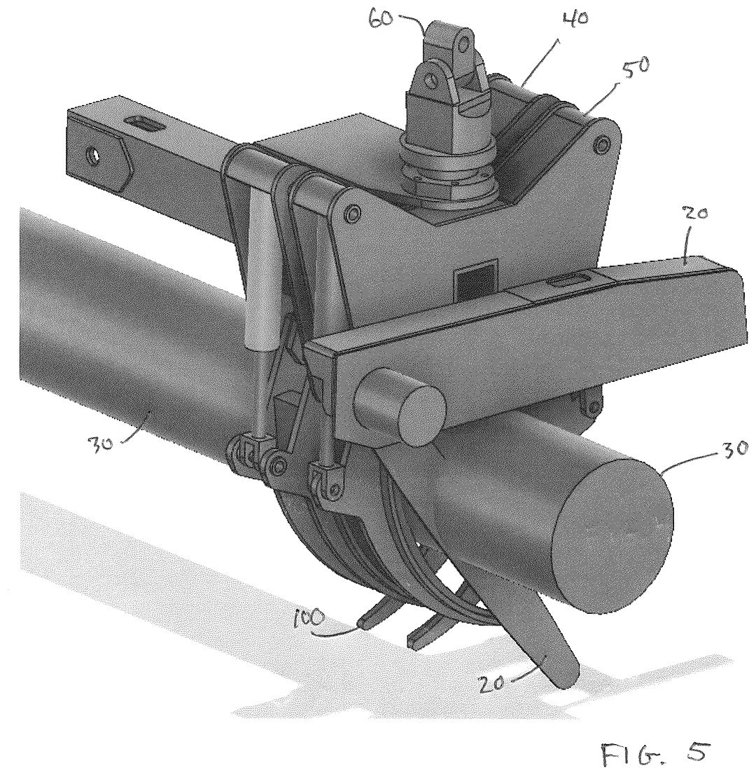

After the log 30 is moved the desired distance (e.g., about the length of a firewood block to be cut), then the stationary first grapple 40 grasps the log 30 firmly and the sliding grapple 50 opens slightly. The sliding second grapple 50 then moves back to a “home position” proximate to the stationary first grapple 40. At this point, the portion of the log 30 extending through the sliding second grapple 50 extends past a saw 20 that is mounted next to or on the sliding second grapple 50 on a side opposite the stationary first grapple 40. See FIG. 5. The saw 20 then cuts the extended log 30 portion to form a firewood block. The process is repeated until the log 30 is fully cut, at which point another log may be picked up by the grapple assembly 10.

In one embodiment, the grapples 40, 50 are relatively narrow and come in close proximity to each other, so as to permit the last short piece of log 30 to be handled. For example, in one embodiment, the grapple assembly 10 will hold a thirty-two inch long log with the stationary first grapple 40 while the sliding second grapple 50 is positionable to cut a sixteen inch piece of log from the end of the thirty-two inch long log. In an alternate embodiment, the grapple assembly 10 will hold a twenty-eight inch long log with the stationary first grapple 40 while the sliding second grapple 50 is positionable to cut a fourteen-inch piece of log from the end of the twenty-eight inch long log. In another embodiment the spacing between the grapples permits a twelve-inch long piece of log to be cut from a twenty-four inch long log. At that point, the sliding second grapple 50 moves the remainder of the log away from the stationary first grapple 40 and drops the remaining piece in a desired location (e.g., on the ground, on a conveyor, or in a log splitter splitting chamber).

The 4-way link of connector 60 on top of the grapple assembly 10 allows the stationary first grapple 40 to align with a log 30 to be picked up. In an alternate embodiment, another type connection is used that is suitable for the circumstances of a particular desired application. By way of example, a 2-way link may be used. By providing a suitable connection, the need to align the skid steer or loader/processor frame to the angle of the log is eliminated. The rotator, which may be powered or not, also allows alignment with a log 30. In one embodiment, rotation of the grapple assembly 10 in at least one direction may be limited to prevent interference between a log and the skid steer, wheel loader, log loader, excavator, telehandler or other carrier machine.

Where the grapple assembly 10 is combined with a splitting assembly, the need for a trough to hold a log is eliminated, providing an advantage over other firewood processor systems.

In an alternate embodiment, feed rollers or wheels may be used in place of the sliding grapple 50. In one embodiment, three feed rollers are used. The feed rollers are located between the fixed grapple 40 and the chainsaw/cutting unit 20, and the feed rollers would pivot upward (similar to the movement of grapple arms). In one embodiment, one feed roller would be mounted in the center (e.g., on the frame) and two feed rollers would pivot upward to a position under the log being processed (e.g., one from each side). The stationary grapple 40 would grab the log to be processed and pick it up; then, the feed rollers would close around the log to support and move the log when the stationary grapple is opened slightly.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. A timber processing attachment for a skid steer, wheel loader, log loader, excavator or telehandler, the attachment including a grapple assembly including a stationary first grapple aligned alongside a second grapple movable on a slider relative to the first grapple; and a log cutter adjacent the second grapple on a side opposite the first grapple.

2. The timber processing attachment of claim 1, wherein the log cutter is attached to the second grapple.

3. The timber processing attachment of claim 1, wherein the log cutter is attached to the slider.

4. The timber processing attachment of claim 1, wherein the log cutter is a chain saw.

5. The timber processing attachment of claim 1, wherein the first grapple includes a plurality of claws and each claw includes a ramp to promote movement of a log past the first grapple.

6. The timber processing attachment of claim 1 including a 4-way link attached to the first grapple to permit side-to-side and front-to-back movement of the first grapple.

7. The timber processing attachment of claim 1 including a rotator attached to the first grapple to permit rotation of the first grapple.

8. The timber processing attachment of claim 6 including a rotator attached to the first grapple to permit rotation of the first grapple.

9. The timber processing attachment of claim 1 wherein the log cutter includes a safety cover.

10. The timber processing attachment of claim 1 wherein the slider includes a frame (a) fixedly attached to the second grapple and (b) movably attached to the first grapple.

11. The timber processing attachment of claim 10, wherein the frame moves hydraulically relative to the first grapple.

12. The timber processing attachment of claim 1, wherein the first grapple is aligned with the second grapple to permit the cutting of a 16-inch long piece of firewood from a 32-inch long log.
